(19) United States
(12) Patent Application Publication
(10) Pub. No.: US 2008/0091975 A1
(43) Pub. Date: Apr. 17, 2008

(54) Method and system for side-channel testing a computing device and for improving resistance of a computing device to side-channel attacks

(76) Inventors: Konstantin Kladko, Santa Clara, CA (US); Yevgeniy Polulyakh, San Jose, CA (US)

Correspondence Address: Yevgeniy Polulyakh, 959 Dionne Way, San Jose, CA, 95133, US

(21) Appl. No.: 11/974,445

(22) Filed: Oct. 13, 2007

Related U.S. Application Data
(60) Provisional application No. 60/852,127, filed on Oct. 17, 2006.

(51) Int. Cl. G06F 11/22

(52) U.S. Cl. 714/25; 714/E11.148

(57) ABSTRACT

Our invention presents an effective method and system which are used to perform side-channel testing of computing devices, as well as to improve resistance of computing devices against side-channel attacks.

### CROSS-REFERENCE TO RELATED APPLICATIONS

THE PRESENT APPLICATION CLAIMS PRIORITY TO THE PROVISIONAL PATENT APPLICATION ENTITLED “METHOD AND SYSTEM FOR SIDE-CHANNEL TESTING A COMPUTING DEVICE AND FOR IMPROVING RESISTANCE OF A COMPUTING DEVICE TO SIDE-CHANNEL ATTACKS” FILED ON OCT. 17, 2006, APPLICATION NO. 60/852,127

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to side-channel testing of computing devices and to designing side-channel attack-resistant devices.

2. Background of the Invention

Computing devices are commonly used in today's world to process and store information.

While a computing device is operational one can measure various physical characteristics of the device or its environment. Examples of such characteristics include electric power consumed by the device, electromagnetic waves emitted by the device, time it takes to perform certain operations and others.

Computing devices execute logical operations which can be composed of a single instruction or a sequence of instructions. In certain cases it is possible to deduce information about operations of the device from the measured physical characteristics of the device or its environment. For example, it may be possible to deduce information about a program running on a device and data processed by the device by measuring electric power consumption of the device or electromagnetic radiation emitted by the device. Such techniques are commonly denoted as side-channel techniques or side-channel attacks. It therefore becomes important to devise efficient methods and systems for side-channel testing of computing devices and for improving resistance of computing devices to side-channel attacks. Such methods and systems are of particular importance for the smart card and computer security industries.

The problem that this invention addresses is to provide efficient method and system for side-channel testing of computing devices and for improving resistance of computing devices to side-channel attacks.

There is currently no commonly used efficient solution to this problem. The current state of the art in this field is the Differential Power Analysis technique. This technique applies to certain cryptographic algorithms only and requires modification of the testing method for each algorithm tested. In addition, it requires expensive equipment and statistical software packages. The testing time is very large since statistical averages have to be taken over a large number of device runs and computational operations. The tester needs to possess graduate level knowledge of cryptography, mathematics and statistics. It was not possible, within this technique or other existing methods, to define universal metrics for resistance to side-channel attacks which would apply across various algorithms and devices. It was also not possible to provide a simple, universal and effective method for designing protections against side-channel attacks.

Therefore, there exists a need in the art to design an efficient, inexpensive and universal method and system for side-channel testing of computing devices and for improving resistance of computing devices to side-channel attacks.

### BACKGROUND OF INVENTION—OBJECTS AND ADVANTAGES

Several objects and advantages of the present invention are:

a) the method and system are inexpensive

b) the tester is not required to possess advanced knowledge of cryptography, mathematics and statistics and only needs basic testing skills

c) the method can easily be automated

d) the method and system can potentially be applied to virtually any measured physical characteristic, program, algorithm or device

e) The testing time is significantly shorter than the testing time for the existing methods and systems in this field

f) It is possible to define simple and universal metrics which can be used to quantify the resistance of a particular device or a category of devices to side-channel attacks.

g) It is possible to define a simple, universal and effective method for improving device resistance to side-channel attacks

### SUMMARY OF THE INVENTION

Our invention specifies a testing method and system which can be used to perform side-channel testing of computing devices at a level of a particular operation. For a particular operation and for particular values of parameters of this operation (if any), one measures one or several physical characteristics observed during execution of this operation. The results of the measurements are denoted as the signature of the operation. One then compares signatures obtained for different operations and values of parameters. If signatures are identical or similar, then there is no significant correlation between the measured set of physical characteristics and the particular operation executed by the device or particular parameters processed by the device. In this case, the device shows significant resistance to the side-channel attack. On the other hand, if signatures show significant dependence on the type of operation or parameters of the operation, the information about the type of operation and parameters of the operation is leaked through the side-channel, and the device may be vulnerable to the side-channel attack. The comparison of signatures can be performed either visually by the tester or by defining mathematical metrics to quantify the degree of resistance of the device to side-channel attacks.

Once resistance of a particular device to the side-channel attack is determined, the following steps can be used together or independently as a method to improve resistance of the device to the side-channel attack:

1) the external and internal operating and design parameters of the device such as input voltage, clock signal amplitude, form, periodicity and frequency, layout of internal electronic components and others can be varied to improve similarity of signatures and to optimize the side-channel resistance metric. Optimization in the space of the parameters can either be done manually or automatically by using mathematical optimization techniques. The computing device can then be designed to perform operations only if the parameters are set to their optimal values. One can also vary the operating parameters for multiple instances of the same device, so that it becomes difficult to relate signatures measured on two different instances of the same device.

2) one can identify an “unsafe” set of operations and parameter values which lead to signatures with unsatisfactory values of side-channel resistance metrics. The algorithm or program executed by the device and the implementation of this algorithm or program can then be varied to minimize or preclude the use of operations from the unsafe set, and therefore to improve the overall side-channel resistance of the device. Alternatively, one can identify a “safe” set of operations and parameters which lead to satisfactory values of side-channel resistance metric. The implementation can then be modified to use only operations and parameters belonging to the safe set.

3) if the signature of a particular operation A depends on the type or values of another operation or set of operations B, such as the previous operation, the next operation, or an operation executed in parallel, then variation of the operation B can be used to vary the signature of operation A, so that it becomes more difficult to relate the measured signature to the type and parameters of the operation A. In particular by adding, deleting or modifying the operation B and its parameters one can vary the signature of the operation A for the same value of parameters of the operation A. The variation of the operation B can either be performed in a single device or across multiple instances of the same device so that it becomes difficult to relate signatures measured on two different instances of the same device.

4) If the signature of a particular operation A depends on the state of the computing device, such as values of the registers, memory, program counter, internal ports and buses, then variation of the state of the computing device can be used to vary the signature of operation A, so that it becomes more difficult to relate the measured signature to the type and parameters of the operation A. The variation of the state of the computing device can be either performed in a single device or across multiple instances of the same device so that it becomes difficult to relate signatures measured on two different instances of the same device.

5) If the signature of a particular operation A depends on the details of hardware design and layout of a particular device, device variations can be introduced in the hardware design and manufacturing process, to make two instances of the same device physically different so that it becomes difficult to relate signatures measured on two instances of the same device.

6) If the same logical function or mathematical calculation can be implemented by alternative sequences of operations, then variation of the operation sequences can be performed for the same logical function or mathematical calculation, so that it becomes more difficult to relate the measured signatures to the type or parameters of the logical function or mathematical calculation.

The system for side-channel testing of computing devices and for designing protections against side-channel attacks includes means to measure a physical characteristic or a set of characteristics of a computing device or its environment during execution of a particular operation and then means to compare signatures and to measure or calculate a mathematical metric or a set of metrics to quantify the degree of similarity of signatures. It also optionally includes the means to change the external and internal parameters of the device such as the external voltage, temperature, clock signal frequency, amplitude, and others.

The foregoing has outlined preferred and alternative features of the present invention so that those skilled in the art may better understand the detailed description that follows. Those skilled in the art should appreciate that they can readily use the present disclosure as a basis for designing or modifying other structures for carrying out the same purposes and/or achieving the same advantages described in the present disclosure. Those skilled in the art should also realize that such equivalent constructions do not depart from the spirit and scope of the present disclosure.

### DETAILED DESCRIPTION

The following discussion is directed to various embodiments of the invention. Unless otherwise specified, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. In this disclosure, numerous specific details may be set forth to provide a sufficient understanding of the embodiment. However, those skilled in the art will appreciate that the invention may be practiced without such specific details. In other instances, well-known elements may have been illustrated in schematic or block diagram form in order not to obscure the disclosure in unnecessary detail. Additionally, some details may have been omitted inasmuch as such details were not considered necessary to obtain a complete understanding of the embodiment, and are considered to be within the understanding of persons of ordinary skill in the relevant art.

One embodiment of the method of side-channel testing of computing devices comprises of the following steps:

a) For a particular operation and for particular values of parameters of this operation (if any) one measures one or several physical characteristics of the device or its environment observed during execution of this operation. The results of the measurements are denoted as the signature of the operation. One may either use a single measurement to obtain the signature, or perform multiple measurements and define the signature as an average of the multiple measurements.

b) One then compares signatures obtained for different operations and values of parameters. One can either measure and compare signatures for each operation and for each value of the parameters, or measure and compare signatures in a sample subset of operations and parameter values.

c) One then uses the following considerations to decide whether the device is resistant to side-channel attacks. If all signatures are identical or similar, then there is no significant correlation between the measured set of physical characteristics and the particular operation executed by the device or particular parameter values processed by the device. In this case, the device shows significant resistance to the side-channel attack. On the other hand, if signatures show significant dependence on the type of operation or parameters of the operation, the information about the type of operation and parameters of operation is leaked through the side-channel, and the device may be vulnerable to the side-channel attack.

d) The comparison of signatures can be performed either visually by the tester or by defining mathematical metrics to measure the degree of similarity of measured signatures. These metrics can then be used to quantify the degree of resistance of the device to the side-channel attack. In particular, increasing similarity of signatures corresponds to increasing resistance of the device to the side-channel attack. The metrics can be either absolute, based on the differences of measured signatures, or relative, where the absolute values are normalized by the overall amplitudes of the measured physical characteristics. In one of the embodiments the side-channel resistance metric can be related to the maximum absolute difference of two power signatures matched in time.

Alternatively, in another embodiment the side-channel resistance metric can be related to the maximum value of the integral over time of the absolute difference of two power signatures matched in time. In another embodiment, which applies to the case where the signature is represented by a sequence of peaks, the power-resistance metric is related to the differences in peak counts, absolute and relative positions, heights, and areas. In another embodiment, all previously described absolute metrics can be transformed into relative metrics by normalizing the corresponding absolute metric by the absolute magnitude of the measured quantity. Such relative metrics are applicable to a wide range of computing devices and can provide a universal way to quantify side-channel resistance of various computing devices.

Another embodiment of the method of side-channel testing of computing devices is similar to the previously described embodiment with the following additional feature: in step a) the computing device emits a synchronization signal, e.g., a signal at the beginning and/or end of an operation or of a set of operations. This signal is used by the measurement device to synchronize measurement of a particular operation.

Another embodiment of the method of side-channel testing of computing devices comprises of the following steps:

a) For a particular operation and for particular values of parameters of this operation (if any) one measures power consumption during execution of this operation. The power consumption may be either power consumption of the device itself, or power consumption of other devices connected or related to the tested device. The results of the measurements are denoted as the power signature of the operation. One may either use a single measurement to obtain the signature, or perform multiple measurements and define the signature as an average of multiple measurements.

b) One then compares signatures obtained for different operations and values of parameters. One can either measure and compare signatures for each operation and for each value of the parameters, or measure and compare signatures in a sample subset of operations and parameter values.

c) One then uses the following considerations to decide whether the device is resistant to the side-channel attack. If all signatures are identical or similar, then there is no significant correlation between the measured set of physical characteristics and the particular operation executed by the device or particular data processed by the device. In this case, the device shows significant resistance to the side-channel attack. On the other hand, if signatures show significant dependence on the type of operation or parameters of the operation, the information about the type of operation and parameters of operation is leaked through the side-channel, and the device may be vulnerable to the side-channel attack.

d) The comparison of signatures can be performed either visually by the tester or by defining mathematical side-channel resistance metrics to measure the degree of similarity of measured signatures. These metrics can then be used to quantify the degree of resistance of the device to the side-channel attack. In particular, increasing similarity of signatures corresponds to increasing resistance of the device to the side-channel attack. The side-channel resistance metrics can be either absolute, based on the differences of measured signatures, or relative, where the absolute values are normalized by the overall amplitudes of the measured physical characteristics. In one of the embodiments the side-channel resistance metric can be related to the maximum absolute difference of two power signatures matched in time. Alternatively, in another embodiment the side-channel resistance metric can be related to the maximum value of the integral over time of the absolute difference of two power signatures matched in time. In another embodiment, which applies to the case where the power signature is represented by a sequence of peaks in power consumption, the power-resistance metric is related to the differences in peak counts, absolute and relative positions, heights, and areas. In another embodiment, all previously described absolute metrics can be transformed into relative metrics by normalizing the corresponding absolute metric by the absolute magnitude of the device power consumption. Such relative metrics are applicable to a wide range of computing devices and can provide a universal way to quantify side-channel resistance of various computing devices.

Another embodiment of the method for side-channel testing of computing devices is similar to the previously described embodiment with the following change: in all steps, electromagnetic emission replaces the power consumption as the physical characteristic measured and used in signatures.

Another embodiment of the method for side-channel testing of computing devices is similar to all previously described embodiments with the following change: in all steps, one applies an external physical entity, such as electric or magnetic field, or radiation, or operates the device outside of its normal operating range and environment to amplify differences in measured signatures. This is performed to test device susceptibility to advanced attacks where external physical entities and variations of the environment may be used.

One embodiment of the system for side-channel testing of computing devices comprises of the following elements:
a) means to measure a physical characteristic or a set of characteristics of a computing device or its environment during execution of a particular operation
b) means to compare signatures and to measure or calculate a mathematical metric or a set of metrics to quantify the degree of similarity of signatures either for all operations and values of parameters or for a sample of operations and values of parameters

Another embodiment of the system of side-channel testing of computing devices is related to the case where the computing device emits a synchronization signal, in particular a signal at the beginning and/or end of each operation. In this case, the following additional element c) is added to the previously described embodiment:
c) means to read the synchronization signal emitted by the computing device and to use the signal to synchronize measurement of the signatures.

Another embodiment of the system of side-channel testing of computing devices is similar to the previously described embodiments with the following addition: one includes means to apply an external physical entity, such as electric or magnetic field, or radiation, or to operate the device outside of its normal operating range and environment in order to amplify differences in measured signatures.

Another embodiment of the system of side-channel testing of computing devices comprises of the following elements:
a) means to measure a power consumption of a computing device or a set of characteristics of a computing device during execution of a particular operation
b) means to compare signatures and to measure or calculate a mathematical metric or a set of metrics to quantify the degree of similarity of signatures either for all operations and values of parameters or for a sample of operations and values of parameters

Another embodiment of the system of side-channel testing of computing devices is similar to the previous embodiment, where measurement of the power consumption is replaced by measurement of the electromagnetic radiation.

One embodiment of the method of improving side-channel resistance of computing devices comprises of the following steps:

1) Measure side-channel resistance metrics using one of the embodiments of the method for side-channel testing of computing devices

2) Improve side-channel resistance metrics by using the step 1) repeatedly and changing the external and internal operating and design parameters of the device such as input voltage, clock signal amplitude or frequency, layout of internal electronic components to improve similarity of signatures and to optimize the side-channel resistance metric. Optimization in the space of parameters can either be done manually or automatically by using mathematical optimization techniques, such as the Newton method or the method of the steepest descent. Once the optimal values of the parameters have been found, modify the device design such that the device performs operations only if the parameters are in the optimal range. This can be done by adding environment sensors to the device. One may also optionally set different operating parameters for multiple instances of the same device, so that it becomes difficult to relate signatures measured on two different instances of the same device.

3) Identify an “unsafe” set of operations and parameter values which lead to signatures with unsatisfactory values of side-channel resistance metrics. Modify the algorithm executed by the device or the implementation of the algorithm to minimize or preclude the use of operations from the unsafe set, and therefore to improve the overall side-channel resistance of the device.

4) Identify a “safe” set of operations and parameters which lead to satisfactory values of side-channel resistance metric. Modify the algorithm executed by the device or the implementation of the algorithm to use operations and parameters belonging to the safe set.

5) Measure signatures for various pairs of operations A and B. If the signature of a particular operation A depends on the type or parameter values of another operation or set of operations B, such as the previous operation, the next operation, or an operation executed in parallel, vary the operation B to change the signature of operation A, so that it becomes more difficult to relate the measured signature to the type or parameters of the operation A. In particular add, delete or modify the operation B or its parameters in order to vary the signature of the operation A for the same value of parameters of the operation A. Perform variation of operation B either in a single device or across multiple instances of the same device so that it becomes difficult to relate signatures measured on two different instances of the same device.

6) Measure signatures for different states of the computing device. If the signature of a particular operation A depends on the state of the computing device, such as values of the registers, memory, program counter, internal ports and buses, then varying the state of the computing device can be used to change the signature of operation A, so that it becomes more difficult to relate the measured signature to the type and parameters of operation A. Perform variation of the state of the computing device either in a single device or across multiple instances of the same device so that it becomes difficult to relate signatures measured on two different instances of the same device.

7) Measure signatures varying the hardware design and layout of the device. If the signature of a particular operation A depends on the details of hardware design and layout of a particular device, introduce device variations in the hardware design and manufacturing process, to make two instances of the same device physically different so that it becomes difficult to relate signatures measured on two instances of the same device.

8) For a logical function or mathematical calculation executed by the device, identify alternative sequences of operations implementing this logical function or mathematical operation. Introduce variation of the alternative sequences so that it becomes more difficult to relate the measured signatures to the type or parameters of the logical function or mathematical calculation. Perform variation of the alternative sequences either in a single device or across multiple instances of the same device so that it becomes difficult to relate signatures measured on two different instances of the same device.

In other embodiments of the method of improving side-channel resistance of computing devices one may choose to use only some of the steps 2), 3), 4), 5), 6), 7), and 8 described above.

1. A testing method for side-channel testing of computing devices, comprising the following steps. Step 1: measuring one or several physical characteristics observed during execution of a particular operation or set of operations and denoting the result as the signature of the operation. Step 2: Comparing the signatures to determine dependence of the signatures on the type of the operation and the parameters of the operation. Step 3: If no significant dependency is found, concluding that the device is resistant against a side-channel attack, otherwise, concluding that the device is not resistant against a side-channel attack.

2. A testing method, as defined in claim 1, where the comparison is performed visually.

3. A testing method, as defined in claim 1, where the comparison is performed by defining and calculating mathematical metrics, such as absolute, based on the differences of measured signatures, or relative, where the absolute values are normalized by the overall amplitudes of the measured physical characteristics.

4. A testing method, as defined in claim 1, where the comparison is performed by defining a metric based on the maximum absolute difference of two power signatures matched in time, or on the maximum value of the integral over time of the absolute difference of two power signatures matched in time, or on the differences in peak counts, absolute and relative positions, heights, and areas under the peaks.

5. A testing method, as defined in claim 1, where multiple measurements are performed, and the signature is defined as an average of the multiple measurements.

6. A testing method, as defined in claim 1, where a representative subset of operations and parameter values is chosen, and the signatures are measured for the subset only.

7. A testing method, as defined in claim 1, where the computing device emits a synchronization signal, e.g., a signal at the beginning and/or end of an operation or a set of operations. This signal is used by the measurement device to synchronize measurement of a particular operation.

8. A testing method, as defined in claim 1, where the measured characteristic is power consumption of the device or related devices, or electromagnetic emission of the device or related devices, or a combination of power consumption and electromagnetic emission.

9. A testing method, as defined in claim 1, where one applies an external physical entity, such as electric or magnetic field, or radiation, or operates the device outside of its normal operating range and environment to amplify differences in measured signatures.

10. A system for side-channel testing of computing devices, comprising the following: means to measure a physical characteristic or a set of characteristics of a computing device and/or its environment during execution of a particular operation, means to compare signatures and to measure or calculate a mathematical metric or a set of metrics to quantify the degree of similarity of signatures either for all operations and values of parameters or for a sample of operations and values of parameters.

11. A system, as defined in claim 10, which includes, in addition, means to read the synchronization signal emitted by the computing device and to use the signal to synchronize measurement of the signatures.

12. A system, as defined in claim 10, which includes, in addition, means to apply an external physical entity, such as electric or magnetic field, or radiation, or to operate the device outside of its normal operating range and environment in order to amplify differences in measured signatures.

13. A system, as defined in claim 10, where the physical characteristic measured is power consumption, electromagnetic emission, or combination of power consumption and electromagnetic emission.

14. A method to improve side-channel resistance of computing devices which comprises the following steps:
Step 1: Measure side-channel resistance metrics using one of the embodiments of the method for side-channel testing of computing devices
Step 2: Perform all, or some of the following steps
a) Improve side-channel resistance metrics by using the step 1) repeatedly and changing the external and internal operating and design parameters of the device such as input voltage, clock signal amplitude or frequency, layout of internal electronic components to improve similarity of signatures and to optimize the side-channel resistance metric. Optimization in the space of parameters can either be done manually or automatically by using mathematical optimization techniques, such as the Newton method or the method of the steepest descent. Once the optimal values of the parameters have been found, modify the device design such that the device performs operations only if the parameters are in the optimal range. This can be done by adding environment sensors to the device. One may also optionally set different operating parameters for multiple instances of the same device, so that it becomes difficult to relate, signatures measured on two different instances of the same device.
b) Identify an “unsafe” set of operations and parameter values which lead to signatures with unsatisfactory values of side-channel resistance metrics. Modify the algorithm executed by the device or the implementation of the algorithm to minimize or preclude the use of operations from the unsafe set, and therefore to improve the overall side-channel resistance of the device.
c) Measure signatures for various pairs of operations A and B. If the signature of a particular operation A depends on the type or parameter values of another operation or set of operations B, such as the previous operation, the next operation, or an operation executed in parallel, vary the operation B to change the signature of operation A, so that it becomes more difficult to relate the measured signature to the type or parameters of the operation A. In particular add, delete or modify the operation B or its parameters in order to vary the signature of the operation A for the same value of parameters of the operation A. Perform variation of operation B either in a single device or across multiple instances of the same device so that it becomes difficult to relate signatures measured on two different instances of the same device.
d) Measure signatures for different states of the computing device. If the signature of a particular operation A depends on the state of the computing device, such as values of the registers, memory, program counter, internal ports and buses, then varying the state of the computing device can be used to change the signature of operation A, so that it becomes more difficult to relate the measured signature to the type and parameters of operation A. Perform variation of the state of the computing device either in a single device or across multiple instances of the same device so that it becomes difficult to relate signatures measured on two different instances of the same device.
e) Measure signatures varying the hardware design and layout of the device. If the signature of a particular operation A depends on the details of hardware design and layout of a particular device, introduce device variations in the hardware design and manufacturing process, to make two instances of the same device physically different so that it becomes difficult to relate signatures measured on two instances of the same device.
f) For a logical function or mathematical calculation executed by the device, identify alternative sequences of operations implementing this logical function or mathematical operation. Introduce variation of the alternative sequences so that it becomes more difficult to relate the measured signatures to the type or parameters of the logical function or mathematical calculation. Perform variation of the alternative sequences either in a single device or across multiple instances of the same device so that it becomes difficult to relate signatures measured on two different instances of the same device.
